(19) United States
(12) Patent Application Publication
(10) Pub. No.: US 2022/0294305 A1
(43) Pub. Date: Sep. 15, 2022

(54) ELECTRIC MOTOR WITH AN AIR-GUIDING ELEMENT

(71) Applicant: ZF FRIEDRICHSHAFEN AG, Friedrichshafen (DE)

(72) Inventor: Philipp NEIDHARDT, Üchtelhausen (DE)

(21) Appl. No.: 17/633,466

(22) PCT Filed: Jul. 24, 2020
(86) PCT No.: PCT/EP2020/070923

§ 371 Date: Feb. 7, 2022

(30) Foreign Application Priority Data
Aug. 9, 2019 (DE) 10 2019 211 972.7

(51) Int. Cl. H02K 5/20; H02K 5/18

(52) U.S. Cl. CPC H02K 5/207; H02K 5/18

(57) ABSTRACT

An electric motor is described, having a rotor, a stator, a housing surrounding the elements having a circumferential wall and an end wall, and an air-guiding element arranged axially between the end wall and an end surface of the rotor. The air-guiding element has a first section that is disk-shaped about the axis (A) and axially spaced apart from the end wall and which extends radially and a second section of tubular form about the axis (A) and which adjoins the first section radially at the inside and which extends in the direction of an end surface of the rotor. The air-guiding element forms an air channel with a heat-exchange region situated between the first section and the end wall and with an intake region running within the second section.

### CROSS REFERENCE TO RELATED APPLICATIONS

This is a U.S. national stage of Application No. PCT/EP2020/070923 filed Jul. 24, 2020. Priority is claimed on German Application No. DE 10 2019 211 972.7 filed Aug. 9, 2019 the content of which is incorporated herein by reference.

### BACKGROUND OF THE INVENTION

1. Field of the Invention

The disclosure relates to an electric motor with an air-guiding element.

2. Description of Related Art

Electric motors have long been known from practice in a variety of applications. An electric motor is known for example from EP 1 642 230 B1. During the operation of electric motors, heat losses occur for example as a result of ohmic losses, eddy currents, and as a result of periodic magnetization procedures, subjecting the components of a motor to thermal loads and restricting the permanently available power and the efficiency of a motor. Specific measures for dissipating this lost heat and for restricting a maximum operating temperature of electric motors are therefore required.

The installation of electric motors as a drive source for electric or hybrid vehicles often requires particular effort to adhere to the permissible thermal operating range owing to the high power requirements and the specified and, for cooling purposes, often less than optimal installation position on a vehicle drive train. It is known and common practice to cool such electric motors by a fluid cooling jacket in thermal communication with the stator. At least the stator with its laminated core and the stator winding located thereon can therefore be kept inside a thermal limit range. Problematic, however, are the winding heads protruding freely from the laminated stator core at both ends, which are located outside the cooling range of the fluid cooling and which have a higher temperature than the winding portions located axially between them. The winding heads release their heat to the elements of the machine, which are arranged in their vicinity. In particular, of these elements, those which are particularly affected are the end faces of the rotor, which can reach a higher temperature than an axially central rotor region, in particular in the case of machines which are comparatively short in the axial direction.

Air cooling which is open to the environment, as explained in EP 1 642 230 B1, is itself not a preferred solution when air filters are used for such vehicle drive motors owing to the established risk of contamination and consequent failure of the electric motor and the drive system. Drive motors are therefore often designed with a closed housing, whereby an active air exchange in the form of a cooling airflow with the environment is not possible.

In the case of permanently excited electric motors, the efficiency is substantially determined by the permanent magnets arranged in the rotor, whereof the magnetization drops as the temperature increases and whereby the power of the drive is consequently reduced. As a result of high temperatures at the winding head of the stator, the rotor end faces, in particular on an interconnection side of the stator winding, can become heated by heat radiation and by convection. Owing to its rotation, the rotor frequently generates an airflow that transports the heat from a winding head directly to the permanent magnets. During operation of an electric motor, the permanent magnets generally have a lower temperature that the winding head. However, the permanent magnets also have a low thermal load capacity, whereby they demagnetize at high temperatures and can therefore permanently impair the performance of the electric motor.

In the case of asynchronous motors, as a result of the heat radiation of the winding heads, the short-circuit rings of a rotor winding frequently designed as a rod winding, which are located at both end faces of the rotor, are additionally subjected to a thermal load, which influences the efficiency of the motor in a disadvantageous manner.

### SUMMARY OF THE INVENTION

One aspect of the invention is an electric motor with improved cooling of the winding heads of the stator.

In an electric motor, during a rotation of the rotor, an airflow is generated at an end face, which is conducted radially outwards from the rotor axis and accelerated in this direction and which can flow radially outside the rotor, past or through a winding head, at a comparatively high temperature. The air, which is thus further heated, can accumulate in a radially outer region inside the housing, in particular in the region of the winding heads of the stator winding, and form eddies and convection rolls in a comparatively small spatial region there. An effective heat exchange with the environment cannot take pace.

In the case of the electric motor proposed here, an air-guiding element is provided between an end wall of the housing and an end face of the rotor, which air-guiding element, during rotation of the rotor, can specifically influence an airflow circulating in this region inside the electric motor and break up the eddies and convection rolls. To this end, the air-guiding element is arranged fixed to the housing and comprises a first portion formed in the shape of a disk around the axis and is axially spaced from the end wall and which extends in the radial direction with respect to the end wall. The air-guiding element furthermore comprises a second portion, which is formed in the shape of a tube around the axis of rotation A of the rotor and which adjoins the first portion on the radially inner side and which extends in the direction of the end face of the rotor. As a result of this configuration, the air-guiding element forms an air channel with a heat exchange region located between the first portion and the end wall and with an intake region extending inside the second portion.

Due to the design of the intake region, the rotor can specifically take in air from regions located axially further away than before, in particular regions located near to the end wall of the housing, transport it to the rotor and accelerate it radially along the end face of the rotor. The air which is conducted radially outwards and heated by the winding heads experiences suction or a negative pressure in the region of the winding heads of the stator, which originates from the region of the heat exchange region which is located on the radially outer side and in which the air having a comparatively higher temperature can enter on the radially outer side and be conducted radially inwards in the air channel As it flows past the end wall of the housing, the air can release at least some of the absorbed heat to the housing, in particular to the axially adjacent end wall, cool down and then in turn enter the intake region, located on the radially inner side, at a lower temperature. A constant circulation of air thus takes place in an end-face rotor region, releasing an amount of the lost heat absorbed from the electric motor, and an increase in temperature at the winding heads can be restricted.

The first and the second portion of the air-guiding element are preferably designed to be circumferentially closed around the axis of rotation to achieve effective cooling. The air-guiding element can either be fixed on the housing, for example on the circumferential wall or on the end wall or on a part connected to the housing. The structures and fasteners required for this can preferably be selected such that they have no, or only an insignificant, influence on a circulating airflow. Cost-effective latching connections lend themselves to simple assembly. The axial spacing of the first disk-shaped portion of the air-guiding element from the end wall depends on the specific configuration of the electric motor. This spacing can be adjusted or optimized through experimentation such that a corresponding cooling effect can be noted in the entire speed range, or a predetermined speed range, of the rotor. Too large or too small a spacing can impair the cooling effect.

According to an advantageous configuration, it is proposed that the air-guiding element is arranged with the second portion radially inside the winding head and coincides with the winding head axially. The air-guiding element is thus directly adjacent to the rotor axially and it is ensured that the airflow pushing radially outwards encompasses the winding region of the stator as completely as possible.

According to an advantageous development, the air-guiding element can have a third portion, which is formed in the shape of a disk and which adjoins the second portion on the radially inner side and which extends radially outwards with an axial spacing radially with respect to the end face of the rotor. As a result, the air-guiding element as a whole has a donut-shaped or toroidal structure which is open on the outer circumferential side and which results in the same flow cell at the end face as the circulating air enclosed inside the motor. By providing the third portion, a specifically conducted and radially outwardly directed airflow can be realized at the end face of the rotor, which firstly encompasses and cools the end face of the rotor and can then pass through the winding head adjacent thereto. The axial spacing of the third portion from the end wall of the rotor can in turn be optimized through experimentation in order to achieve the greatest possible cooling effect for the winding heads of the stator winding depending on a speed or a speed range.

The air-guiding element can furthermore advantageously be made from an insulating material, in particular a temperature resistant plastic. Manufacturing the air-guiding element from plastic is advantageous in that air gaps between the winding head and the housing are especially not reduced. The fastening of the air-guiding element is preferably likewise realized by plastic elements so that, in some circumstances, it is moreover equally possible for the creepage distance to even be somewhat increased with respect to a simple housing wall. The third disk-shaped portion of the air-guiding element can form a thermal barrier for the elements of the electric motor, which are located in the direction of the end wall and can reliably protect these elements from an undesired increase in temperature.

According to a particular configuration, the electric motor can be designed as a permanently excited internal rotor machine. In this machine, the rotor can have a plurality of circumferentially spaced and axially extending permanent magnets, which are located radially inside the stator winding and the winding heads. The magnets or magnet portions arranged at the end faces of the rotor are located in the heat transfer region of a winding head and can absorb radiant heat therefrom in the event of an undesired increase in temperature. Owing to the design of the air-guiding element, the comparatively colder air taken in by the intake region can firstly cool the radially inner magnets or an end-face cover plate which is in thermal contact therewith and can then cool the winding heads located radially further outward. The thermal load on the magnets caused by the winding heads can thus drop appreciably. The axial temperature distribution inside the magnets, i.e. over the axial extent of the rotor, can be homogenized. In a design of the electric motor as a permanently excited external rotor machine, the winding heads arranged radially inward of the permanent magnets of the rotor and the permanent magnets can likewise be cooled by the effect of the air-guiding element.

According to a particular alternative configuration, the electric motor can be designed as an asynchronous machine, wherein the rotor has, at the end face, a short-circuit ring which is located radially inside the stator winding and the winding heads. An asynchronous machine conventionally has a rod winding incorporated in grooves of the rotor, wherein the individual rod conductors on the rotor are connected to a short-circuit ring at the end face, in particular by casting or welding. As explained above with reference to the cooling effect on permanent magnets, the short-circuit ring of an asynchronous ring can likewise be effectively cooled or protected against undesired overheating by the proposed air-guiding element.

According to yet another configuration of the electric motor, it can be provided that the stator has an interconnection device for the interconnection of the stator winding. This interconnection device can preferably be arranged radially inside a winding head and be located axially between the first portion and the second portion and extend radially at least partially inside the third portion. The interconnection device can comprise a plurality of ring-shaped or ring-segment-shaped conductors with a comparatively high current load capacity compared to individual conductors of the stator winding, which ring-shaped or ring-segment-shaped conductors can also be subjected to a high thermal load. As a result of the proposed arrangement of the interconnection device, the rotor can be at least partially shielded with respect to heat radiated from it. The interconnection device is thus surrounded by the air-guiding element in a U-shape. A resultant thermal load on the rotor can therefore be restricted.

A further improvement of the cooling effect by the air-guiding element can be achieved in that the end wall has a bearing flange extending axially in the direction of the rotor to support a rotor shaft. On the one hand, the intake region is formed between the second portion and the bearing flange and, on the other, the air flowing there can also release a further amount of heat to the bearing flange and cool down even further.

For even further improvement of the cooling effect, the end wall of the housing can have in particular radially extending cooling ribs on the inner side. Alternatively or additionally, cooling ribs can be formed on the end wall on the outer side opposite the air-guiding element. All in all, the surface and the heat exchange can be increased as a result of such cooling ribs.

The cooling effect can be even further improved by an active cooling device of the electric motor, i.e. by forced cooling. To this end, the electric motor can have a closed fluid cooling circuit with a heat exchanger and the housing can have cooling channels for conducting a cooling fluid. The required cooling channels can extend in or on the circumferential wall of the housing, wherein heat absorbed by the end wall is firstly transported into the region of the circumferential wall via heat conduction and transferred there to the cooling fluid. The cooling channels can further advantageously also be formed in or on the end wall, i.e. as end wall cooling and/or also in the region of a bearing flange, so that even more effective heat dissipation from the electric motor is thus possible.

### BRIEF DESCRIPTION OF THE DRAWINGS

In the drawings:

FIG. 1 is a schematic axial sectional illustration of an electric motor, designed as a permanently excited synchronous machine, with an air-guiding element;

FIG. 2 is a schematic illustration of an airflow formed in the housing of the electric motor, between the housing wall and the rotor end face, under the influence of the air-guiding element; and

FIG. 3 is a schematic partial illustration of an electric motor, designed as an asynchronous machine, with an air-guiding element.

### DETAILED DESCRIPTION OF THE PRESENTLY PREFERRED EMBODIMENTS

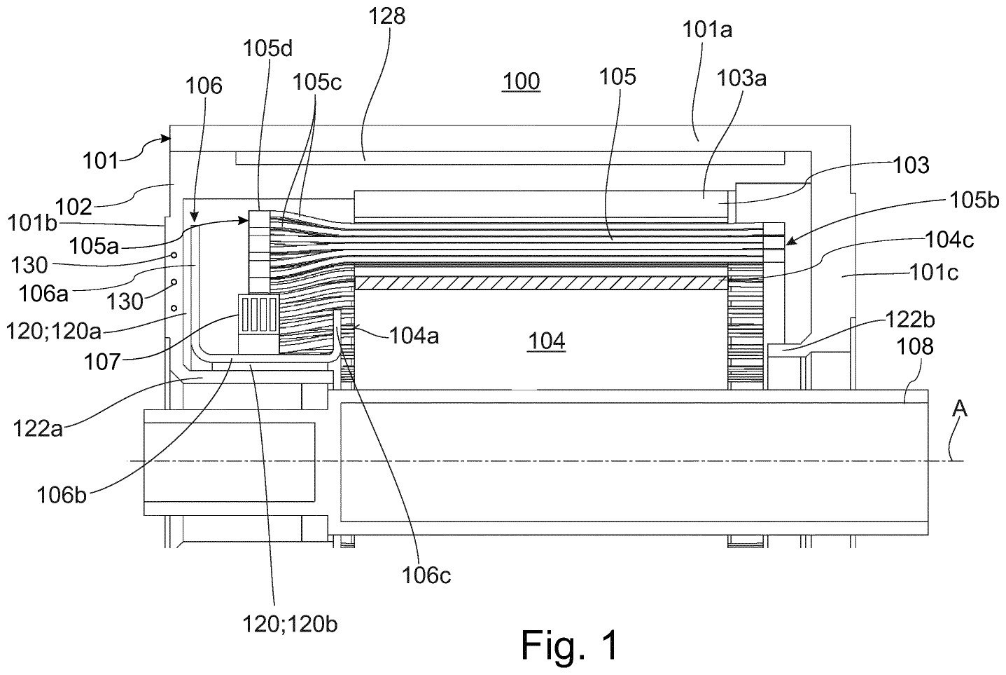

FIG. 1 shows a schematic illustration of an electric motor 100 designed as a permanently excited synchronous machine in an internal rotor design. The electric motor 100 is provided as a drive in an electric or hybrid vehicle. The electric motor 100 comprises a stator 103 fixed to a stator carrier 102, with a stator winding 105 arranged on a laminated stator core 103a. At the end face of the stator 103, winding heads 105a, b protrude axially over a laminated stator core 103a. The stator winding in the present case is designed as a hairpin winding and comprises conductor elements 105c designed as hairpins and inserted into stator grooves. At an end face of the electric motor 100, the individual conductor elements 105c are connected at contact points 105d to form a plurality of coils by welding or soldering the free ends to one another. By an interconnection device 107, the coils are in turn connected to a plurality of ring-shaped or ring-segment-shaped connection conductors in a predetermined manner according to the intended phase count and a predetermined interconnection type. The interconnection device 107 is furthermore connectable or connected to an energy source, for example a drive battery or a generator, by connection conductors, which are not illustrated in the drawing here.

The electric motor 100 furthermore comprises a rotor 104, which is rotatable about an axis A, and a housing 101, which surrounds the stator 103 and the rotor 104 with a circumferential wall 101a and with two end walls 101b; 101c. The housing 101 in the present case is at least partially formed by the stator carrier 102. The end walls 101b; 101c each have a bearing flange 122a, b extending axially in the direction of the rotor 104 to support a rotor shaft 108. A plurality of circumferentially spaced and axially extending permanent magnets 104c are furthermore inserted into slots inside the rotor 104, which permanent magnets are therefore located radially inside the stator winding 105 and the winding heads 105, 105b. In their axial end regions, the permanent magnets 104c are thermally influenced by heat radiation released by the winding heads 105a, b and can heat up compared to a region located axially between them, i.e. they can reach a higher temperature.

In FIGS. 1-3, an air-guiding element 106 can furthermore be seen, which is arranged axially between the end wall 101b and an end face 104a of the rotor 104 and which can specifically influence an airflow circulating inside the electric machine 100 to enable a cooling effect on the rotor 104 and the stator 103. The air-guiding element 106 is produced from an insulating material, preferably a plastic, for example a thermoplastic or thermosetting plastic which is thermally dimensionally stable under operating conditions, and generally has an approximately donut-shaped or toroidal structure which is open on the outer circumferential side. The air-guiding element 106 in the present case is fixed on the end wall 101b and on the bearing flange 122a by plastic elements, which are not illustrated in the drawing.

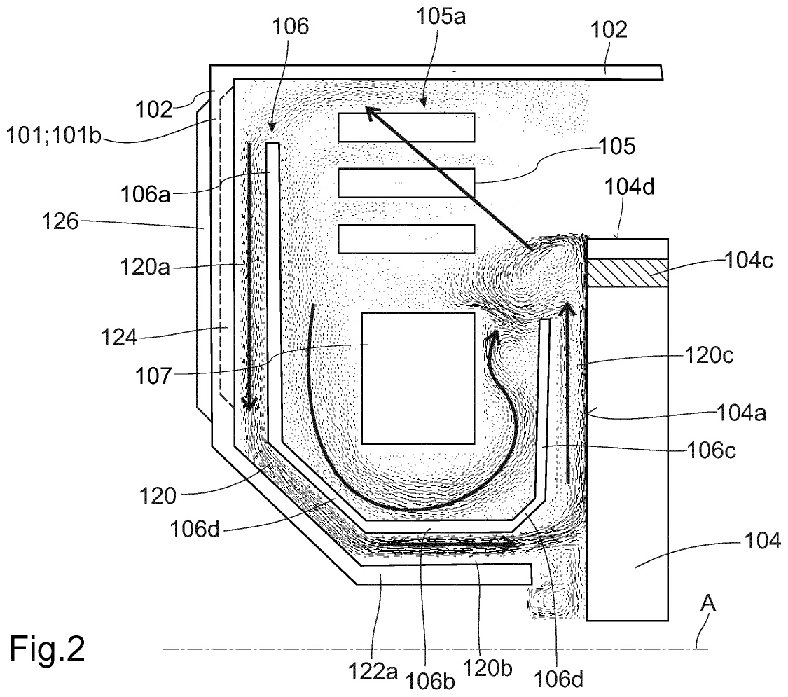

The air-guiding element 106 has a first portion 106a, which is formed in the shape of a disk around the axis A and is axially spaced from the end wall 101b, and which extends in the radial direction with respect to the end wall 101b. As can be seen in FIGS. 1, 2, the axial spacing of the first portion 106a from the end wall 101b is comparatively small compared to its axial spacing from the end face 104a of the rotor 104. The air-guiding element 106 has a second portion 106b, which is formed in the shape of a tube around the axis A and which adjoins the first portion 106a on the radially inner side and which extends in the direction of the end face 104a of the rotor 104. It can be seen that the air-guiding element 106 forms an air channel 120 with a heat exchange region 120a located between the first portion 106a and the end wall 101b and an intake region 120b extending inside the second portion 106b. The intake region 120b in the exemplary embodiment extends between the second portion 106b and the bearing flange 122a.

The air-guiding element 106 furthermore has a third portion 106c, which is formed in the shape of a disk and which adjoins the second portion 106b on the radially inner side and which extends radially outwards with an axial spacing radially with respect to the end face 104a of the rotor 104.

It can be seen that the air-guiding element 106 is arranged with the second portion 106b radially inside the winding head 105a and coincides with the winding head 105a axially. It can furthermore be seen that the interconnection device 107 is arranged radially inside a winding head 105a and that it is located axially between the first portion 106a and the second portion 106b and extends radially at least partially inside the third portion 106c.

FIG. 2 shows a detail of the electric motor in a schematic illustration with the air-guiding element 106 explained above, which is arranged between the end wall 101b, designed as an end shield and having the bearing flange 122a, on one side and the rotor end face 104a on the other side. The air-guiding element 106 has been modified slightly compared to the illustration of FIG. 1 and has a respective, somewhat conical, bridge portion 106d between the first portion 106a and the second portion 106b and between the second portion 106b and the third portion 106c. The bridge portions 106d can differ in size and be designed according to the characteristics specified in the present case. In FIG. 1, the bridge portion 106d is merely shown as rounded transitions. Fastening elements for the arrangement of the air-guiding element 106 are not illustrated in FIG. 2. The flow direction of an airflow generated under the influence of the air-guiding element 106 there is indicated by the arrows.

A laminar airflow is generated in the air channel 120 formed between the air-guiding element 106 and the end wall 101 with the bearing flange 122a. This flow is driven by a rotation of the rotor 104, wherein, by the heat exchange region 120a and by the intake region 120b, air from the area near to the end wall 101b is taken in towards the rotor 104 via the bearing flange 122a. This air has a comparatively low temperature as a result of a heat exchange with the end wall 101b and the bearing flange 122a and is accelerated radially outwards in an acceleration region 120c of the air channel 120 at the end face 104a. Along its path, the air flowing past can cool the permanent magnets 104c, which are located at the rotor 104 there and heated during operation, at the end face. The cooling in this region can have an effect on the mean value of the temperature distribution along the entire axial extent of the permanent magnet 104c. This temperature mean value can be reduced by up to 5K.

The airflow breaks away at an outer circumferential surface 104d of the rotor 104 and forms a radially outwardly dispersing eddy, which can pass radially further outwards through the winding head 105a and thereby likewise cools the winding head 105a and entrains the air heated in this region. In this case, the temperature of the winding head 105a can be reduced by ca. 1K. The airflow the experiences suction as a result of the negative pressure in the air channel 120 and can enter the radially outer region of the air-guiding element 106 again. This flow cycle is maintained so long as the rotor 104 is rotating. In the region enclosed by the air-guiding element 106 and in which the interconnection device 107 is located, a flow cycle likewise forms according to the arrow shown therein, which flow cycle, to a certain extent, moreover exchanges air with the airflow explained above. A cooling effect is therefore likewise present at the interconnection device 107.

To promote the cooling effect, radially extending cooling ribs 124 are provided on the inner side of the end wall 101b for improved heat absorption. Cooling ribs 126 can likewise be formed on the outer side of the end wall 101b, which is opposite the air-guiding element 106, for improved heat release.

Referring to FIG. 1, a closed fluid cooling circuit can moreover be provided on the electric motor 100 to increase the cooling effect, to which end cooling channels 128; 130 for conducting a cooling fluid are formed between the circumferential wall 101a and the stator carrier 102 or only on the circumferential wall 101a and/or on the end wall 101b of the housing 101.

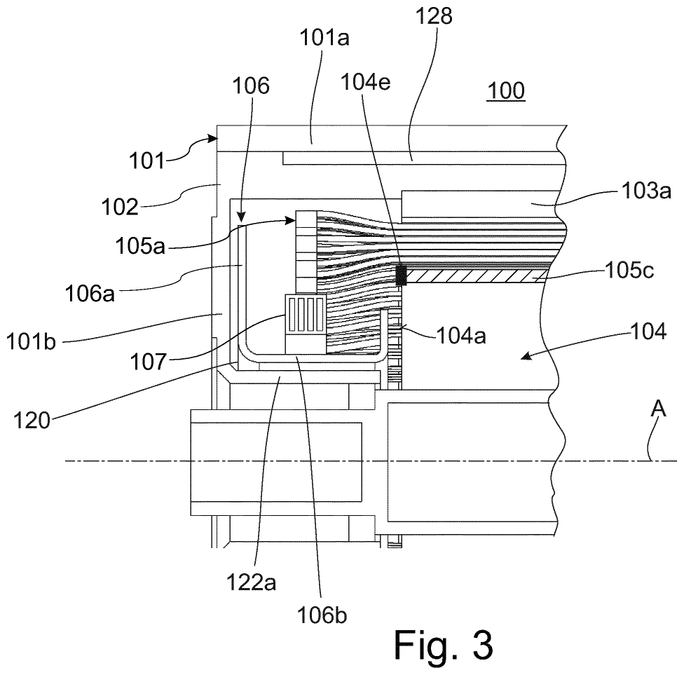

According to a further exemplary embodiment as an alternative to FIG. 1, the electric motor 100, as is shown in part in a modified form in FIG. 3, can be designed as an asynchronous machine. The asynchronous machine in this case should be constructed identically to the machine explained by FIG. 1, wherein, instead of the permanent magnets 104c, the rotor 104 merely has a rod winding, inserted into grooves, with conductor elements 105c and with a short-circuit ring 104e arranged at the end face 104a. This short-circuit ring 104e is located radially inside the stator winding 105 and the winding heads 105a. The airflow explained with reference to FIG. 1 likewise applies, wherein the air flowing radially past the end face 104a now encompasses and cools the short-circuit ring 104e before the air passes through the winding head 105a in the manner explained above.

In the exemplary embodiments, the air-guiding element 106 is arranged merely at one end face of the electric motor. It goes without saying that such an air-guiding element 106 can also be arranged at both end faces.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. An electric motor, comprising:
a stator with a stator winding and an end-face winding head, a rotor rotatable about an axis A;
a housing, which surrounds the stator and the rotor with a circumferential wall and at least one end wall; and
an air-guiding element fixed to the housing and arranged axially between the at least one end wall and an end face of the rotor, and comprising:
a first portion formed in a shape of a disk around the axis A and is axially spaced from the at least one end wall and which extends in a radial direction with respect to the axis A and the at least one end wall; and
a second portion formed in the shape of a tube around the axis A and adjoins the first portion on a radially inner side of the first portion and which extends in a direction of the end face of the rotor; and
an air channel formed by the air-guiding element with a heat exchange region located between the first portion and the at least one end wall and an intake region extending inside the second portion.

12. The electric motor as claimed in claim 11, wherein the air-guiding element is arranged with the second portion radially inside the end-face winding head and coincides with the end-face winding head axially.

13. The electric motor as claimed in claim 11, wherein the air-guiding element further comprises:
a third portion formed in a shape of a disk and which adjoins the second portion on an axially inner side of the second portion and which extends radially outwards with an axial spacing radially with respect to the end face of the rotor.

14. The electric motor as claimed in claim 11, wherein the air-guiding element is made from an insulating material.

15. The electric motor as claimed in claim 11, wherein the electric motor is a permanently excited internal rotor machine and the rotor has a plurality of circumferentially spaced and axially extending permanent magnets, which are located radially inside the stator winding and the end-face winding head.

16. The electric motor as claimed in claim 11, wherein the electric motor is an asynchronous machine and the rotor has, at the end face, a short-circuit ring located radially inside the stator winding and the end-face winding head.

17. The electric motor as claimed in claim 13, wherein the stator has an interconnection device for an interconnection of the stator winding, which is arranged radially inside a winding head and which extends axially between the first portion and the second portion and radially at least partially inside the third portion.

18. The electric motor as claimed in claim 11, wherein the at least one end wall has a bearing flange extending axially in the direction of the rotor to support a rotor shaft, wherein the intake region is formed between the second portion and the bearing flange.

19. The electric motor as claimed in claim 11, wherein the at least one end wall has radially extending cooling ribs on an inner side and/or the at least one end wall has cooling ribs on an outer side opposite the air-guiding element.

20. The electric motor as claimed in claim 11, wherein the housing has cooling channels for conducting a cooling fluid.

21. The electric motor as claimed in claim 14, wherein the insulating material is a temperature-resistant plastic.
